(19) United States
(12) Patent Application Publication
(10) Pub. No.: US 2008/0243469 A1
(43) Pub. Date: Oct. 2, 2008

(54) Emulation system

(75) Inventor: Fumihito Baisho, Tachikawa (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 12/079,430

(22) Filed: Mar. 26, 2008

(30) Foreign Application Priority Data
Mar. 27, 2007 (JP) 2007-81764

(51) Int. Cl. G06F 9/455

(52) U.S. Cl. 703/26

(57) ABSTRACT

An emulation system emulates a sound IC having a built-in ROM and reproducing sound data stored in the built-in ROM or received sound data. The emulation system includes: a sound data storage section storing sound data to be stored in the built-in ROM; a command reception section; a command conversion section that performs a command conversion process that converts a built-in ROM data reproduction command into a data-attached reproduction command having a format interpretable by the sound IC when the command conversion section has received the built-in ROM data reproduction command; and a converted command transmission section. The command conversion section reads sound data from the sound data storage section based on the received built-in ROM data reproduction command, and generates the data-attached reproduction command to which the read sound data is attached.

Japanese Patent Application No. 2007-81764, filed on Mar. 27, 2007, is hereby incorporated by reference in its entirety.

### BACKGROUND OF THE INVENTION

The present invention relates to an emulation system which emulates a sound IC with a built-in ROM which stores sound data.

An electronic instrument has been known which includes a sound IC with a built-in ROM which stores sound data provided by the customer, and outputs a sound message. Operation check or sound quality evaluation by reading sound data from the ROM cannot be performed until an IC product is completed. Therefore, a ROM emulation device which emulates the operation of reading data from the ROM is provided, and the IC and the ROM emulation device are connected. This makes it possible to perform sound quality evaluation on sound data provided by the customer or operation check on a host program created by the customer in a state in which the IC is mounted on a product developed by the customer in the evaluation stage before the ROM is fixed.

However, a known ROM emulator requires a dedicated terminal for connecting the IC and the ROM emulator. Therefore, an IC which does not have a dedicated terminal for a ROM emulator cannot be evaluated using a known ROM emulator.

Moreover, when a dedicated terminal used only for debugging is provided, a reduction in size and cost of a product is hindered.

### SUMMARY

According to a first aspect of the invention, there is provided an emulation system that emulates a sound integrated circuit (IC) having a built-in read-only memory (ROM) and reproducing sound data stored in the built-in ROM or received sound data, the emulation system comprising:

a sound data storage section storing sound data to be stored in the built-in ROM;

a command reception section receiving a command issued to the sound IC;

a command conversion section that performs a command conversion process that converts a built-in ROM data reproduction command instructing reproduction of the sound data stored in the built-in ROM into a data-attached reproduction command to which reproduction target sound data is attached when the command conversion section has received the built-in ROM data reproduction command, the data-attached reproduction command having a format interpretable by the sound IC that reproduces the attached reproduction target sound data; and

a converted command transmission section that transmits the data-attached reproduction command to the sound IC,

the command conversion section reading sound data from the sound data storage section based on the received built-in ROM data reproduction command, and generating the data-attached reproduction command to which the read sound data is attached.

According to a second aspect of the invention, there is provided an emulation system comprising a host processor, a sound integrated circuit (IC) that reproduces sound data stored in a built-in read-only memory (ROM) or received sound data based on a command received from the host processor, and an emulator that emulates the sound IC,

wherein the sound IC includes:

the built-in ROM storing sound data;

a sound reproduction section that converts reproduction target sound data into an outputtable format and reproduces the converted sound data; and

a command processing section that transfers the reproduction target sound data to a sound output section based on a command received from the host processor;

wherein, when the command processing section has received a data-attached reproduction command, the command processing section transfers attached sound data to the sound reproduction section;

wherein, when the command processing section has received a built-in ROM data reproduction command, the command processing section reads the reproduction target sound data from the built-in ROM, and transfers the read reproduction target sound data to the sound reproduction section;

wherein the emulator includes:

a sound data storage section storing sound data to be stored in the built-in ROM;

a command reception section receiving a command issued to the sound IC;

a command conversion section that performs a command conversion process that converts the built-in ROM data reproduction command instructing reproduction of the sound data stored in the built-in ROM into the data-attached reproduction command to which the reproduction target sound data is attached when the command conversion section has received the built-in ROM data reproduction command, the data-attached reproduction command having a format interpretable by the sound IC that reproduces the attached reproduction target sound data; and

a converted command transmission section that transmits the data-attached reproduction command to the sound IC,

the command conversion section reading sound data from the sound data storage section based on the received built-in ROM data reproduction command, and generating the data-attached reproduction command to which the read sound data is attached.

According to a third aspect of the invention, there is provided an emulation method for emulating a sound integrated circuit (IC) having a built-in read-only memory (ROM) and reproducing sound data stored in the built-in ROM or received sound data, the emulation method comprising:

storing sound data in a storage section, the sound data being to be stored in the built-in ROM;

receiving a command issued to the sound IC;

performing a command conversion process that converts a built-in ROM data reproduction command instructing reproduction of the sound data stored in the built-in ROM into a data-attached reproduction command to which reproduction target sound data is attached when the built-in ROM data reproduction command has been received, the data-attached reproduction command having a format interpretable by the sound IC that reproduces the attached reproduction target sound data; and

transmitting the data-attached reproduction command to the sound IC,

wherein, in the step of performing the command conversion process, sound data is read from the sound data storage section based on the received built-in ROM data reproduction command, and the data-attached reproduction command to which the read sound data is attached is generated.

### BRIEF DESCRIPTION OF THE SEVERAL VIEWS OF THE DRAWING

FIG. 1 is a diagram illustrative of a sound IC.

FIG. 2 is a diagram illustrative of a configuration example of an emulation system.

FIG. 3 is a diagram illustrative of another configuration example of an emulation system.

FIG. 4 is a diagram illustrative of implementation of an emulation system.

FIGS. 5A and 5B show configuration examples of a ROM emulation conversion board and a ROM emulator application.

FIG. 6 is a diagram illustrative of a sound data file successive reproduction function.

FIG. 7 is a diagram illustrative of a silent data insertion function.

FIG. 8 shows a message flow between a host CPU and a sound IC performed by a ROM emulator.

FIG. 9 shows a message flow from a host CPU to a sound IC.

FIG. 10 shows a message flow from a sound IC to a host CPU.

FIG. 11 shows another message flow from a sound IC to a host CPU.

### DETAILED DESCRIPTION OF THE EMBODIMENT

The invention may provide an emulation system which efficiently implements sound data quality check or operation check with software without providing a dedicated terminal to an IC in a state in which a sound IC with a built-in ROM which stores sound data is provided in a product.

(1) According to one embodiment of the invention, there is provided an emulation system that emulates a sound integrated circuit (IC) having a built-in read-only memory (ROM) and reproducing sound data stored in the built-in ROM or received sound data, the emulation system comprising:

a sound data storage section storing sound data to be stored in the built-in ROM;

a command reception section receiving a command issued to the sound IC;

a command conversion section that performs a command conversion process that converts a built-in ROM data reproduction command instructing reproduction of the sound data stored in the built-in ROM into a data-attached reproduction command to which reproduction target sound data is attached when the command conversion section has received the built-in ROM data reproduction command, the data-attached reproduction command having a format interpretable by the sound IC that reproduces the attached reproduction target sound data; and

a converted command transmission section that transmits the data-attached reproduction command to the sound IC,

the command conversion section reading sound data from the sound data storage section based on the received built-in ROM data reproduction command, and generating the data-attached reproduction command to which the read sound data is attached.

The term “sound IC” refers to a semiconductor integrated circuit which reproduces sound. The built-in ROM of the sound IC may be formed as a mask ROM.

The emulation system may be implemented by causing a general-purpose computer (PC) or the like to execute an emulation program (software). The sound data storage section may be implemented by storing sound data to be stored in the built-in ROM of the sound IC in a RAM or the like provided outside or inside the PC.

The emulation system according to this embodiment converts the built-in ROM data reproduction command into the data-attached reproduction commands equivalent to the built-in ROM data reproduction command (equivalent in a sense that identical sound is output), and transmits the converted command to the sound IC. The built-in ROM of the sound IC can be emulated by storing sound data to be stored in the built-in ROM of the sound IC in the sound data storage section of the emulation system. Since the generated sound data is reproduced by the sound IC, sound data quality check or operation check with software can be performed in a state in which the sound IC is provided in the target product.

According to this embodiment, since the sound IC can reproduce sound corresponding to the data-attached reproduction commands received from the host, sound data quality check or operation check with software can be performed in a state in which the sound IC is provided in the target product without providing a debugging terminal to the sound IC.

The sound IC may include: the built-in ROM storing sound data; a sound reproduction section that converts reproduction target sound data into an outputtable format and reproduces the converted sound data; and a command processing section that transfers the reproduction target sound data to a sound output section based on a command received from the host processor;

when the command processing section has received a data-attached reproduction command, the command processing section may transfer attached sound data to the sound reproduction section; and

when the command processing section has received a built-in ROM data reproduction command, the command processing section may read the reproduction target sound data from the built-in ROM, and transfer the read reproduction target sound data to the sound reproduction section.

The data stored in the ROM is data obtained by compressing sound data in a predetermined format (e.g., PCM data). The sound reproduction section may perform decompression, DA conversion, or the like in order to convert the sound data read from the built-in ROM into data in an outputtable format.

(2) In this emulation system, when the command conversion section has received a combined data reproduction command instructing combination of a plurality of pieces of sound data stored in the built-in ROM and reproduction of the combined data, the command conversion section may read a plurality of pieces of corresponding sound data from the sound data storage section, combine the sound data to generate combined sound data, and generate the data-attached reproduction command to which the generated combined sound data is attached.

When the command processing means of the sound IC has received a combined data reproduction command which instructs combination of a plurality of pieces of sound data stored in the built-in ROM and reproduction of combined data, the command processing means may read a plurality of pieces of sound data stored in the built-in ROM, combine the plurality of pieces of sound data read from the built-in ROM to generate combined sound data, and transfer the combined sound data to the sound reproduction section.

(3) In this emulation system, when the command conversion section has received a combined data reproduction command instructing insertion of a silent interval between a plurality of pieces of sound data stored in the built-in ROM, combination of the plurality of pieces of sound data, and reproduction of the combined data, the command conversion section may read a plurality of pieces of corresponding sound data from the sound data storage section, combine the read sound data and silent data corresponding to the silent interval to generate combined sound data, and generate the data-attached reproduction command to which the generated combined sound data is attached.

The silent interval is provided between pieces of sound data. A silent interval for a designated length may be inserted by designating the length of the silent interval using a command or the like.

When the command processing means of the sound IC has received a combined data reproduction command which instructs insertion of a silent interval between a plurality of pieces of sound data stored in the built-in ROM, combination of the plurality of pieces of sound data, and reproduction of combined data, the command processing means may read a plurality of pieces of sound data stored in the built-in ROM, combine the plurality of pieces of sound data read from the built-in ROM and silent data corresponding to the silent interval to generate combined sound data.

(4) In this emulation system, when the command conversion section has received a combined data reproduction command instructing combination of a plurality of pieces of sound data stored in the built-in ROM and reproduction of the combined data, the command conversion section may read a plurality of pieces of corresponding sound data from the sound data storage section, and generate a plurality of the data-attached reproduction commands to each of which a piece of the read sound data is attached; and the converted command transmission section may transmit the plurality of generated data-attached reproduction commands to the sound IC.

When generating combined sound data, a plurality of pieces of compressed sound data stored in the sound data storage section is read. The plurality of pieces of compressed data is decompressed to generate a plurality of pieces of decompressed data, and an uncompressed combined sound data is generated based on the decompressed data. The uncompressed combined sound data is compressed, and attached to the sound reproduction command. Therefore, when generating combined sound data, decompression and compression are required. When individually reading a plurality of pieces of sound data and attaching each piece of sound data to the reproduction commands without combining the sound data, decompression and compression become unnecessary. Therefore, the processing load can be reduced while increasing the processing speed. Therefore, it is advantageous to select this mode when it suffices to individually check the reproduction state of each piece of sound data.

When receiving a combined data reproduction command which instructs combination of a plurality of pieces of sound data stored in the built-in ROM and reproduction of combined data, a mode in which the command is converted into a reproduction command to which combined sound data is attached and a mode in which the command is converted into a plurality of reproduction commands to which each piece of sound data is attached without combining the plurality of pieces of sound data may be selected.

(5) The emulation system may comprise:

a protocol conversion device that functions as the command reception section and the converted command transmission section; and

a general-purpose computer that functions as the command conversion section, wherein the protocol conversion device may include:

a first communication section that transmits and receives data to and from a host processor or the sound IC according to a first communication protocol;

a second communication section that transmits and receives data to and from the general-purpose computer according to a second communication protocol; and

a control section that transmits data received from the host processor or the sound IC to the general-purpose computer, and transmits data received from the general-purpose computer to the host processor or the sound IC; and

wherein the general-purpose computer may perform the command conversion process based on a sound reproduction command received from the host processor through the protocol conversion device, and transmit the converted sound reproduction command to the sound IC through the protocol conversion device.

(6) In this emulation system, the control section of the protocol conversion device may determine whether or not a command received from the host processor is the data-attached reproduction command, and transmit the received command to the sound IC without performing a protocol conversion process and the command conversion process when the received command has been determined to be the data-attached reproduction command.

(7) According to one embodiment of the invention, there is provided an emulation system comprising a host processor, a sound integrated circuit (IC) that reproduces sound data stored in a built-in read-only memory (ROM) or received sound data based on a command received from the host processor, and an emulator that emulates the sound IC,

wherein the sound IC includes:

the built-in ROM storing sound data;

a sound reproduction section that converts reproduction target sound data into an outputtable format and reproduces the converted sound data; and

a command processing section that transfers the reproduction target sound data to a sound output section based on a command received from the host processor;

wherein, when the command processing section has received a data-attached reproduction command, the command processing section transfers attached sound data to the sound reproduction section;

wherein, when the command processing section has received a built-in ROM data reproduction command, the command processing section reads the reproduction target sound data from the built-in ROM, and transfers the read reproduction target sound data to the sound reproduction section;

wherein the emulator includes:

a sound data storage section storing sound data to be stored in the built-in ROM;

a command reception section receiving a command issued to the sound IC;

a command conversion section that performs a command conversion process that converts the built-in ROM data reproduction command instructing reproduction of the sound data stored in the built-in ROM into the data-attached reproduction command to which the reproduction target sound data is attached when the command conversion section has received the built-in ROM data reproduction command, the data-attached reproduction command having a format interpretable by the sound IC that reproduces the attached reproduction target sound data; and

a converted command transmission section that transmits the data-attached reproduction command to the sound IC,

the command conversion section reading sound data from the sound data storage section based on the received built-in ROM data reproduction command, and generating the data-attached reproduction command to which the read sound data is attached.

(8) According to one embodiment of the invention, there is provided an emulation method for emulating a sound integrated circuit (IC) having a built-in read-only memory (ROM) and reproducing sound data stored in the built-in ROM or received sound data, the emulation method comprising:

a storing step of storing sound data in a sound data storage section, the sound data being to be stored in the built-in ROM;

a receiving step of receiving a command issued to the sound IC;

a command conversion step of performing a command conversion process that converts a built-in ROM data reproduction command instructing reproduction of the sound data stored in the built-in ROM into a data-attached reproduction command to which reproduction target sound data is attached when the built-in ROM data reproduction command has been received, the data-attached reproduction command having a format interpretable by the sound IC that reproduces the attached reproduction target sound data; and

a converted command transmitting step of transmitting the data-attached reproduction command to the sound IC,

wherein, in the step of performing the command conversion process, sound data is read from the sound data storage section based on the received built-in ROM data reproduction command, and the data-attached reproduction command to which the read sound data is attached is generated.

(9) In this emulation method, wherein, in the command conversion step, when a combined data reproduction command instructing combination of a plurality of pieces of sound data stored in the built-in ROM and reproduction of the combined data is received, a plurality of pieces of corresponding sound data may be read from the sound data storage section, the pieces of the read sound data may be combined to generate combined sound data, and the data-attached reproduction command to which the generated combined sound data is attached may be generated.

(10) In this emulation method, wherein, in the command conversion step, when a combined data reproduction command instructing insertion of a silent interval between a plurality of pieces of sound data stored in the built-in ROM, combination of the plurality of pieces of sound data, and reproduction of the combined data is received, a plurality of pieces of corresponding sound data may be read from the sound data storage section, the pieces of the read sound data and silent data corresponding to the silent interval may be combined to generate combined sound data, and the data-attached reproduction command to which the generated combined sound data is attached may be generated.

(11) In this emulation method,

wherein, in the command conversion step, when a combined data reproduction command instructing combination of a plurality of pieces of sound data stored in the built-in ROM and reproduction of the combined data is received, a plurality of pieces of corresponding sound data may be read from the sound data storage section, and a plurality of the data-attached reproduction commands to each of which a piece of the read sound data is attached may be generated; and

wherein, in the converted command transmission step, the generated data-attached reproduction commands may be transmitted to the sound IC.

The embodiments of the invention will be described in detail below, with reference to the drawings. Note that the embodiments described below do not in any way limit the scope of the invention laid out in the claims herein. In addition, not all of the elements of the embodiments described below should be taken as essential requirements of the invention.

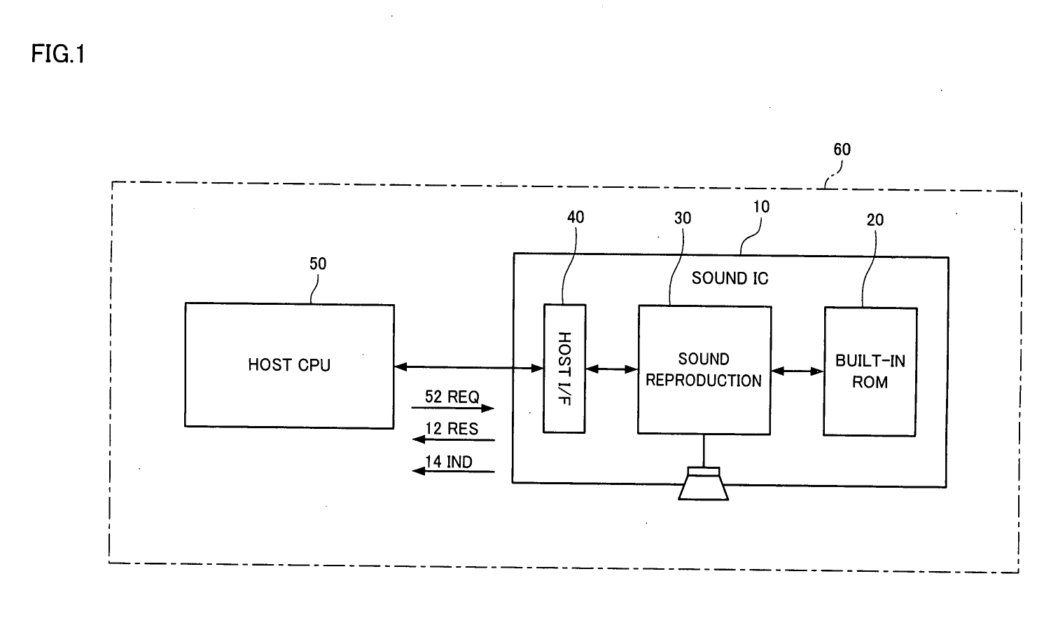

FIG. 1 is a diagram illustrative of a sound IC as a target of an emulation system according to one embodiment of the invention.

A host CPU 50 is a built-in microcomputer or the like which is provided in an electronic instrument 60 and performs main control and overall control of the electronic instrument 60.

A sound IC 10 is provided in the electronic instrument 60 together with the host CPU 50. The sound IC 10 operates based on a control command from the host CPU 50. The sound IC 10 operates as a companion chip hosted by the host CPU 50 provided in the electronic instrument 60. The sound IC 10 includes a command I/F, and is controlled based on a command issued by the host CPU 50. As the command, commands relating to startup, data transfer, and sound processing (e.g., reproduction/stop) of the sound IC are provided, for example.

The sound IC 10 includes a host I/F 40, a sound reproduction section 30, and a built-in ROM 20.

The built-in ROM 20 stores sound data, and is formed of a mask ROM or the like. The built-in ROM 20 stores sound data such as PCM data (e.g., ADPCM/AAC-LC) which can be reproduced by the sound reproduction section in a compressed state.

The sound reproduction section 30 converts (decodes or DA-converts) reproduction target sound data into data in an outputtable format, and outputs the converted sound data. For example, the sound reproduction section 30 decompresses compressed sound data, DA-converts the decompressed sound data, and outputs the converted sound data.

The host I/F 40 controls communication of a command and data with the host 50. For example, the host I/F 40 processes a command received from the host (e.g., startup, data transfer, or sound processing (e.g., reproduction/stop) of the sound IC), or performs a handshake process of communication with the host.

The host I/F 40 functions as a command processing means which transfers reproduction target sound data to the sound output section based on a command received from the host. When the host I/F 40 has received a reproduction commands, the host I/F 40 transfers the attached sound data to the sound reproduction section 30. When the host I/F 40 has received a built-in ROM data reproduction command, the host I/F 40 reads reproduction target sound data from the built-in ROM 20, and transfers the read sound data to the sound reproduction section 30.

When the host I/F 40 has received a combined data reproduction command which instructs the host I/F 40 to combine a plurality of pieces of sound data stored in the built-in ROM 20 and output the combined data, the host I/F 40 may read a plurality of pieces of sound data stored in the built-in ROM 20, combine the plurality of pieces of sound data read from the built-in ROM 20 to generate combined sound data, and transfer the combined sound data to the sound reproduction section.

When the host I/F 40 has received a combined data reproduction command which instructs the host I/F 40 to insert a silent interval between a plurality of pieces of sound data stored in the built-in ROM 20, combine the plurality of pieces of sound data, and then output the combined data, the host I/F 40 may read a plurality of pieces of sound data stored in the built-in ROM 20, combine the plurality of pieces of sound data read from the built-in ROM 20 and silent data corresponding to the silent interval to generate combined sound data.

The sound IC 10 is controlled based on a control command 52 from the host CPU 50. The host CPU 50 communicates with the sound IC 10 by SPI (clock-synchronized three-line or four-line serial transfer).

The control commands include a stream command with sound data (corresponding to the reproduction commands) and a ROM access command which loads sound data from the built-in ROM (corresponding to the built-in ROM data reproduction command). The stream command (reproduction commands) is a command for inputting sound data from the host CPU 50 and reproducing the input sound data. The stream command corresponds to the reproduction commands which instructs reproduction of the attached sound data. The ROM access command (built-in ROM data reproduction command) is a command for reading sound data stored in the built-in ROM 20 of the sound IC 10 and reproducing the read sound data. The ROM access command corresponds to the built-in ROM data reproduction command which instructs reproduction of sound data stored in the built-in sound data ROM. The ROM access command may instruct successive reproduction of a plurality of pieces of sound data stored in the ROM.

The sound IC 10 selectively reproduces sound data stored in the ROM 20 included in the IC based on the control command 52, or stream-reproduces sound data input from the host CPU 50.

Specifically, when the sound IC 10 has received a ROM access command (corresponding to the built-in ROM data reproduction command), the sound IC 10 selectively reproduces sound data stored in the built-in ROM 20. Specifically, when the sound IC 10 has received a successive reproduction command (command that instructs the sound IC 10 to combine a plurality of pieces of sound data stored in the built-in ROM and reproduce the combined sound data), the sound IC 10 successively reproduces a plurality of pieces of sound data stored in the built-in ROM 20. When the sound IC 10 has received a stream command (reproduction commands), the sound IC 10 stream-reproduces sound data input from the host CPU 50.

Communication with the host CPU may be performed by UART transfer or SPI transfer, for example. As a reproduction audio format, a compression format such as an ADPCM/AAC-LC format may be supported.

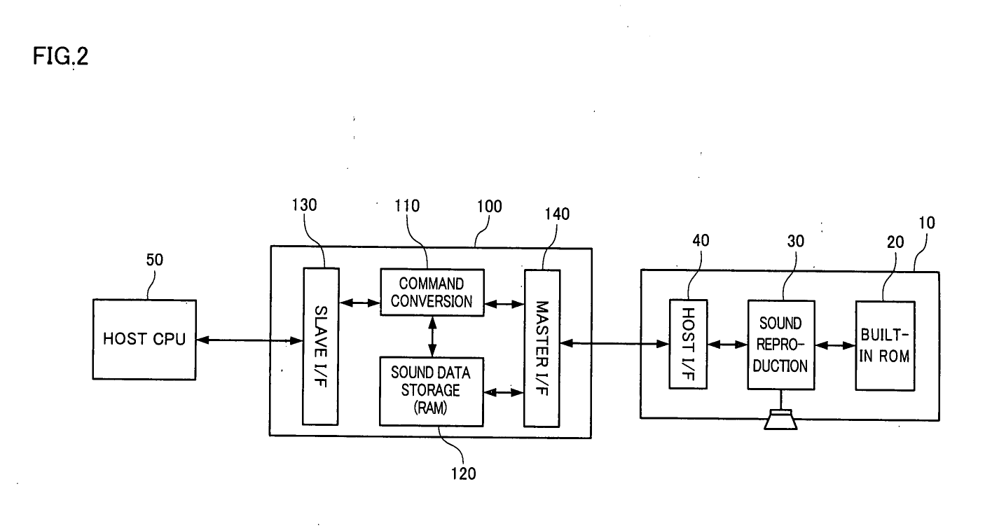

FIG. 2 is a diagram illustrative of a configuration example of the emulation system according to this embodiment.

The emulation system according to this embodiment emulates the sound IC 10 which reproduces sound data stored in the built-in ROM 20 or sound data attached to a command based on a command received from the host CPU 50. The emulation system includes a ROM emulator 100.

The ROM emulator 100 is connected to the host CPU 50 and the sound IC 10, and can communicate with the host CPU 50 and the sound IC 10.

The ROM emulator 100 may be implemented by a general-purpose computer such as a personal computer (PC). The ROM emulator 100 includes a command conversion section 110, a sound data storage section 120, a slave I/F 130, and a master I/F 140. The command conversion section 110, the slave I/F 130, and the master I/F 140 may be implemented by causing a CPU to execute a predetermined program. The sound data storage section 120 may be implemented by a built-in RAM, an external RAM, or the like.

The sound data storage section (RAM) 120 stores sound data to be stored in the built-in ROM 20 of the sound IC 10, and functions as a sound data storage section.

The slave I/F 130 functions as a command reception section which receives a command input to the sound IC 10.

When the command conversion section 110 has received a built-in ROM data reproduction command which instructs reproduction of sound data stored in the built-in ROM 20 of the sound IC 10, the command conversion section 110 functions as a command conversion section which performs a command conversion process which converts the received built-in ROM data reproduction command into a reproduction command to which reproduction target sound data is attached and which has a format which can be interpreted by the sound IC which reproduces the attached sound data. The command conversion section 110 reads sound data from the sound data storage section based on the received built-in ROM data reproduction command, and generates the reproduction command to which the read sound data is attached.

When the command conversion section 110 has received a combined data reproduction command which instructs the command conversion section 110 to combine a plurality of pieces of sound data stored in the built-in ROM and output the combined data, the command conversion section 110 may read a plurality of pieces of sound data corresponding to the command from the sound data storage section, combine the plurality of pieces of sound data read from the sound data storage section to generate combined sound data, and generate the reproduction command to which the generated combined sound data is attached.

When the command conversion section 110 has received a combined data reproduction command which instructs the command conversion section 110 to insert a silent interval between a plurality of pieces of sound data stored in the built-in ROM, combine the plurality of pieces of sound data, and then output the combined data, the command conversion section 110 may read a plurality of pieces of sound data corresponding to the command from the sound data storage section, combine the plurality of pieces of sound data read from the sound data storage section and silent data corresponding to the silent interval to generate combined sound data, and generate the reproduction command to which the generated combined sound data is attached.

When the command conversion section 110 has received a combined data reproduction command which instructs the command conversion section 110 to combine a plurality of pieces of sound data stored in the built-in ROM and output the combined data, the command conversion section 110 may read a plurality of pieces of sound data corresponding to the command from the sound data storage section, and generate the reproduction command to which each piece of sound data read from the sound data storage section is attached.

The master I/F 140 functions as a converted command transmission section which transmits the converted reproduction commands to the sound IC.

In general, operation check or sound quality evaluation by storing sound data provided by the customer in the built-in ROM 20 of the sound IC 10 and reading the sound data from the built-in ROM 20 cannot be performed until an IC product is completed. According to this embodiment, sound quality evaluation on sound data provided by the customer or operation check on a host program created by the customer can be performed in a state in which the sound IC 20 is mounted on a product developed by the customer in the evaluation stage before the built-in ROM 20 is fixed.

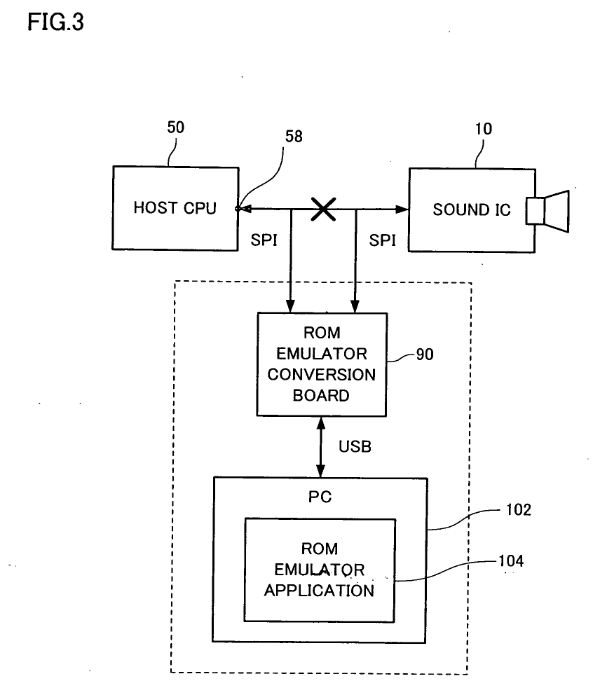

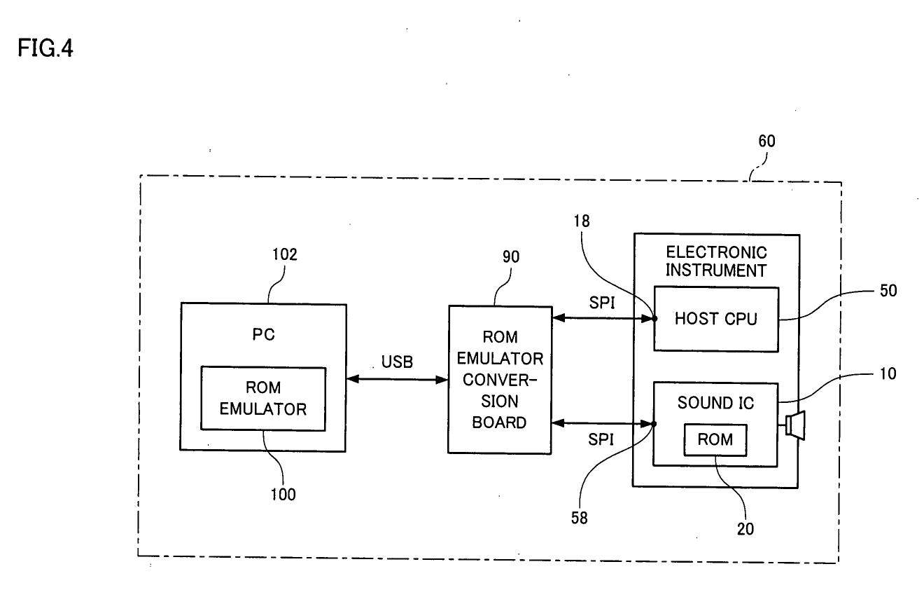

FIG. 3 is a diagram illustrative of another configuration example of the emulation system according to this embodiment. FIG. 4 is a diagram illustrative of implementation of the emulation system.

An emulation system 100′ according to this embodiment may include an application tool (ROM emulator application) 104 which emulates the ROM 20 provided in the sound IC 10 on a PC, a personal computer (PC) 102 on which the application tool 104 operates, and a ROM emulator conversion board 90 which is a dedicated hardware bridge board which connects the sound IC 10 and the host CPU 50.

The ROM emulator conversion board 90 is connected to a terminal group 58 of the host CPU 50 for communicating with the sound IC 10, a terminal group 18 of the sound IC 10 for communicating with the host CPU 50, and an input/output terminal 106 (e.g., USB terminal) of the PC 102. The ROM emulator conversion board 90 communicates with the host CPU 50 and the sound IC 10 in a data format according to the protocol (SPI) employed for the host CPU 50 and the sound IC 10, and communicates with the PC 102 in a data format according to the protocol (USB) employed for the PC 102.

The ROM emulator conversion board 90 may convert data received from the host CPU 50 or the sound IC 10 into a USB format and transmit the converted data to the PC 102. The ROM emulator conversion board 90 may convert data received from the PC 102 into an SPI format, and transmit the converted data to the host CPU 50 or the sound IC 10. The ROM emulator conversion board 90 functions as a protocol conversion device 90 which includes a first communication section which transmits and receives data to and from the host CPU 50 or the sound IC 10 according to a first communication protocol, a second communication section which transmits and receives data to and from the general-purpose computer 102 according to a second communication protocol, and a control section which transmits data received from the host CPU 50 or the sound IC 10 to the general-purpose computer 102, and transmits data received from the general-purpose computer 102 to the host CPU 50 or the sound IC 10.

The general-purpose computer 102 receives a sound reproduction command from the host CPU 50 through the ROM emulator conversion board 90. A reproduction commands generated by the command conversion process is transmitted to the sound IC 10 through the protocol conversion device 90.

The ROM emulator conversion board 90 may have a function of filtering a command depending on the type of command transmitted from the host CPU 50, and may transmit a command other than a ROM access command (command for reading sound data from the built-in ROM of the sound IC) to the sound IC 10 without going through the ROM emulator application 104 of the PC 102.

As shown in FIG. 4, the ROM emulator conversion board 90 may be implemented by an SPI-USB conversion board, for example.

As shown in FIG. 4, the host CPU 50 and the sound IC 10 are connected to the emulation system in a state in which the host CPU 50 and the sound IC 10 are provided in the electronic instrument. The sound IC is tested in this state.

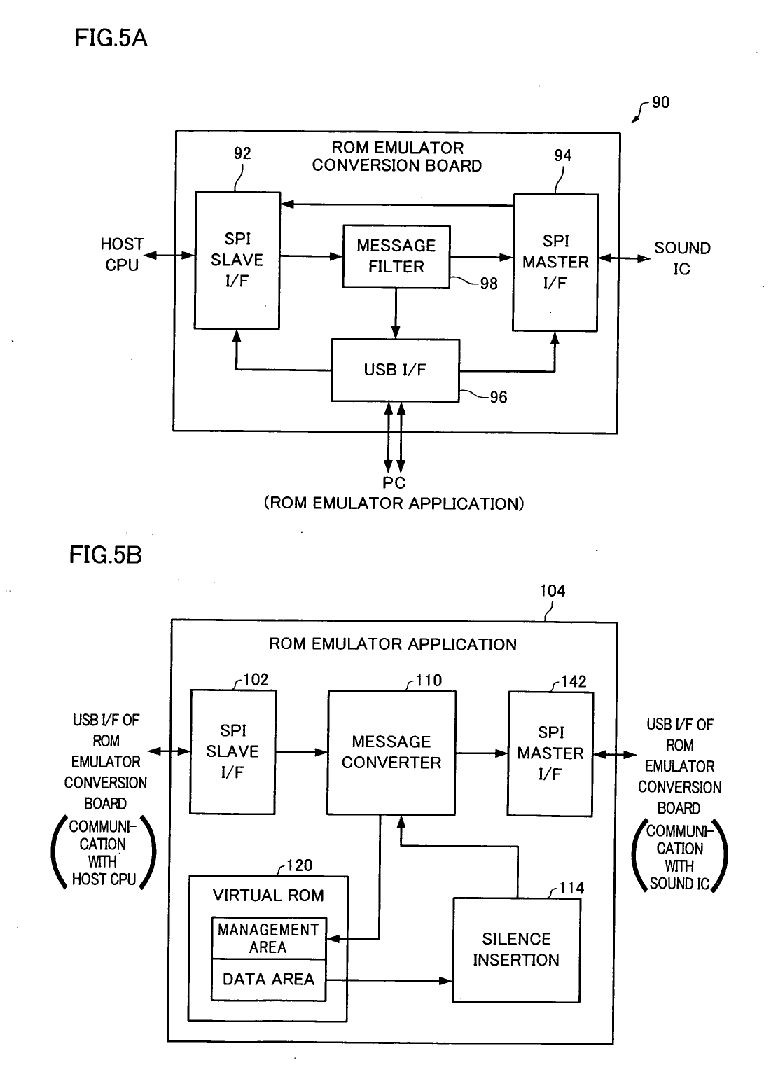

FIGS. 5A and 5B show configuration examples of the ROM emulation conversion board and the ROM emulator application.

The ROM emulation conversion board 90 includes a USB I/F 96, an SPI slave I/F 92, and an SPI master I/F 94. The ROM emulation conversion board 90 converts a data format between the USB protocol and the SPI protocol. The ROM emulation conversion board 90 includes a message filter 98. The ROM emulation conversion board 90 determines whether or not the received sound reproduction command is a ROM access command. When the ROM emulation conversion board 90 has determined that the received sound reproduction command is a command (e.g., sound IC startup command or attached data reproduction instruction command) other than a ROM access command, the ROM emulation conversion board 90 transmits the received sound reproduction command to the sound IC without performing the protocol conversion process and the command conversion process.

When the SPI slave I/F 92 has received data from the host, the received data is transmitted to the message filter 98. The message filter 98 determines whether or not the data from the host is a ROM access command (command for reading sound data from the built-in ROM of the sound IC). When the message filter 98 has determined that the data from the host is a ROM access command, the received data is transmitted to the PC through the USB I/F 96. When the message filter 98 has determined that the data from the host is not a ROM access command, the received data is transmitted to the sound IC 10 through the SPI master I/F 94.

The USB I/F 96 receives data from the PC. The received data is transmitted to the host CPU through the SPI slave I/F 92, or transmitted to the sound IC 10 through the SPI master I/F 94.

The ROM emulator application 104 includes a message converter 110, a slave I/F 132, a master I/F 142, a virtual ROM 120, and a silence insertion section 114.

The message converter is an application for implementing the process of the command conversion section. The slave I/F 132 is an application for implementing a handshake process with the host CPU through the ROM emulator conversion board shown in FIG. 5A. The master I/F 142 is an application for implementing a handshake process with the sound IC 10 through the ROM emulator conversion board shown in FIG. 5A.

The virtual ROM 120 is a sound data storage section (RAM) which stores sound data to be stored in the built-in ROM of the sound IC.

When a combined data reproduction command which instructs the silence insertion section 114 to insert a silent interval between a plurality of pieces of sound data stored in the built-in ROM, combine the plurality of pieces of sound data, and then output the combined data has been received, the silence insertion section 114 (application) reads a plurality of pieces of sound data corresponding to the command from the sound data storage section, combines the plurality of pieces of sound data read from the sound data storage section and silent data corresponding to the silent interval to generate combined sound data, and generates the reproduction command to which the generated combined sound data is attached. A plurality of pieces of sound data corresponding to the command may be read from the sound data storage section (virtual ROM) 120, and while designating the length of silent data to be 0, the plurality of pieces of sound data read from the sound data storage section (virtual ROM) 120 may be combined without inserting the silent interval to generate combined sound data.

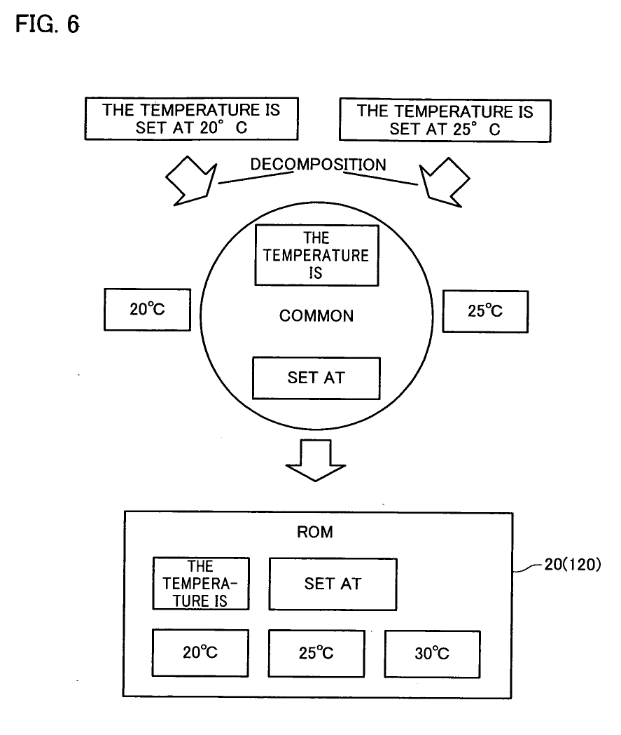

FIG. 6 is a diagram illustrative of a sound data file successive reproduction function.

When the sound IC has received a combined data reproduction command which instructs the sound IC to combine a plurality of pieces of sound data stored in the built-in ROM and reproduce (output) the combined data, the sound IC may read a plurality of pieces of sound data corresponding to the command from the built-in ROM 20, combine the plurality of pieces of sound data read from the built-in ROM 20 to generate combined sound data, and transfer the combined sound data to the sound reproduction section.

When the ROM emulator has received a combined data reproduction command which instructs the ROM emulator to combine a plurality of pieces of sound data stored in the built-in ROM and output the combined data, the ROM emulator may read a plurality of pieces of sound data corresponding to the command from the sound data storage section 120, combine the plurality of pieces of sound data read from the sound data storage section 120 to generate combined sound data, and generate a reproduction commands which can be interpreted by the sound IC based on the generated combined sound data.

For example, when sentences “The temperature is set at 20° C.” and “The temperature is set at 25“C” are provided as output sound, sound data is provided in units of phrases (clauses) such as “The temperature is”, “set at”, “20° C.”, “25° C.”, and “30° C.”, and stored in the built-in ROM 20 so that the sound data can be read in phrase units instead of providing the entire sentence as one piece of sound data. This reduces the overlapping portion of the sound data so that the capacity of the built-in ROM 20 which stores the sound data can be reduced.

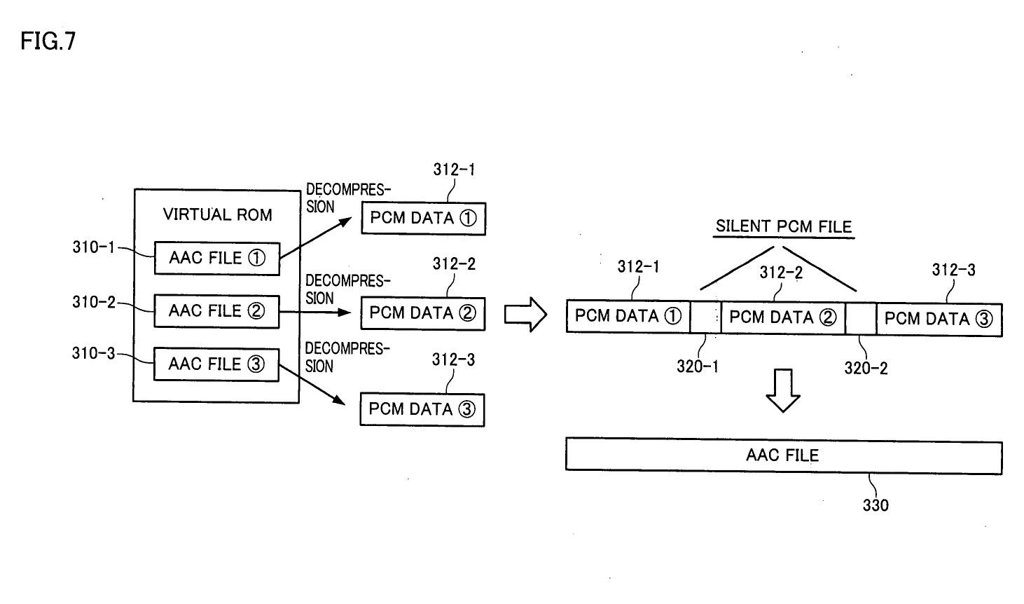

FIG. 7 is a diagram illustrative of a silent data insertion function.

When the sound IC has received a combined data reproduction command which instructs the sound IC to insert a silent interval between a plurality of pieces of sound data stored in the built-in ROM, combine the plurality of pieces of sound data, and then output the combined data, the sound IC may read a plurality of pieces of sound data stored in the built-in ROM, and combine the plurality of pieces of sound data read from the built-in ROM and silent data corresponding to the silent interval to generate combined sound data.

When the ROM emulator has received a combined data reproduction command which instructs the ROM emulator to insert a silent interval between a plurality of pieces of sound data stored in the built-in ROM, combine the plurality of pieces of sound data, and then output the combined data, the ROM emulator may read a plurality of pieces of sound data corresponding to the command from the sound data storage section, and combine the plurality of pieces of sound data read from the sound data storage section and silent data corresponding to the silent interval to generate combined sound data.

When combining a plurality of pieces of sound data, a plurality of combination target sound data files 310-1, 310-2, and 310-3 in clause units are read from the built-in ROM or the virtual ROM, and decompressed into PCM data 312-1, 312-2, and 312-3. Silent PCM data 320-1 and silent PCM data 320-2 are respectively inserted between the PCM data 312-1 and the PCM data 312-2 and between the PCM data 312-2 and the PCM data 312-3 based on silence insertion time setting values t1 and t2 transmitted from the host CPU as commands. The PCM data 312-1, 312-2, and 312-3 is again compressed into one piece of PCM data in a predetermined format to create a combined file 330.

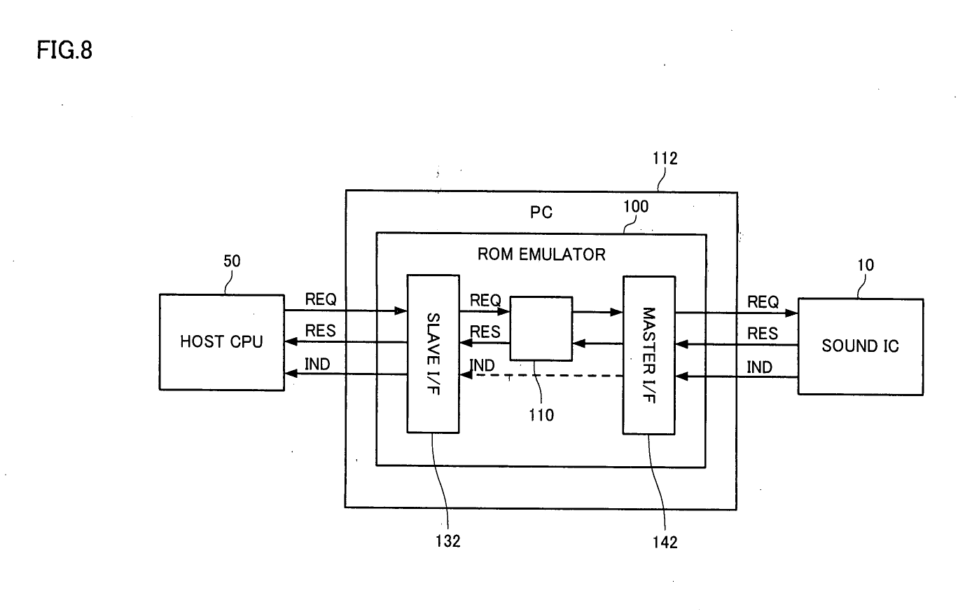

FIG. 8 shows a message flow between the host CPU and the sound IC performed by the ROM emulator. The host CPU 50 and the sound IC 10 transmit and receive a message by handshaking. Therefore, the host CPU 50 and the ROM emulator (PC) 100 as well as the ROM emulator (PC) 100 and the sound IC 10 must communicate by handshaking.

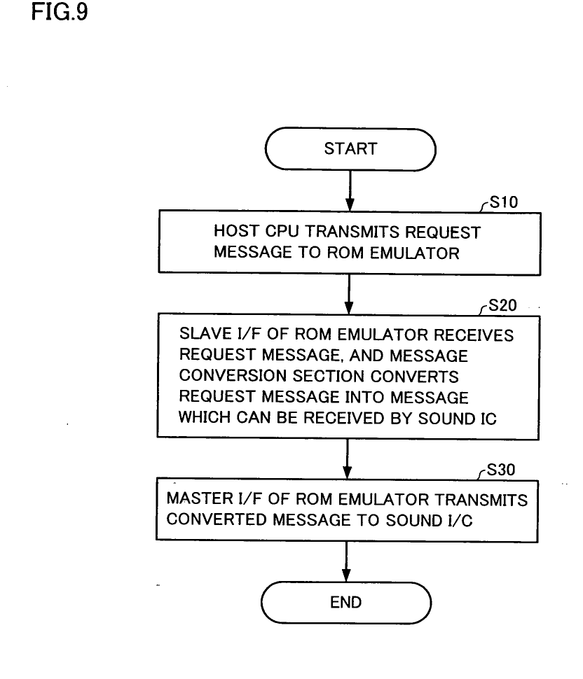

FIG. 9 shows a message flow (request message) from the host CPU to the sound IC.

The host CPU transmits a request message to the ROM emulator (step S10).

The slave I/F of the ROM emulator receives the request message, and the message conversion section converts the request message into a message which can be received by the sound IC (step S20).

The master I/F of the ROM emulator transmits the converted message to the sound I/C (step S30).

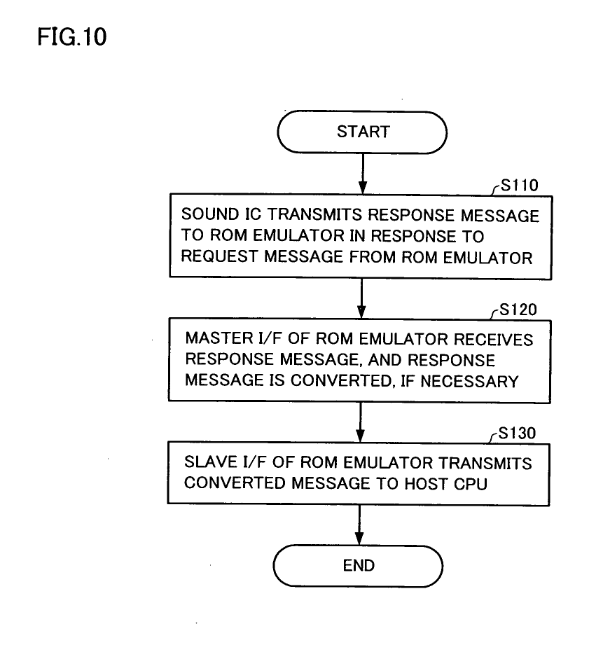

FIG. 10 shows a message flow (response message) from the sound IC to the host CPU.

The sound IC transmits a response message to the ROM emulator in response to the request message from the ROM emulator (step S110).

The master I/F of the ROM emulator receives the response message, and the response message is converted, if necessary (step S120).

The slave I/F of the ROM emulator transmits the converted message to the host CPU (step S130).

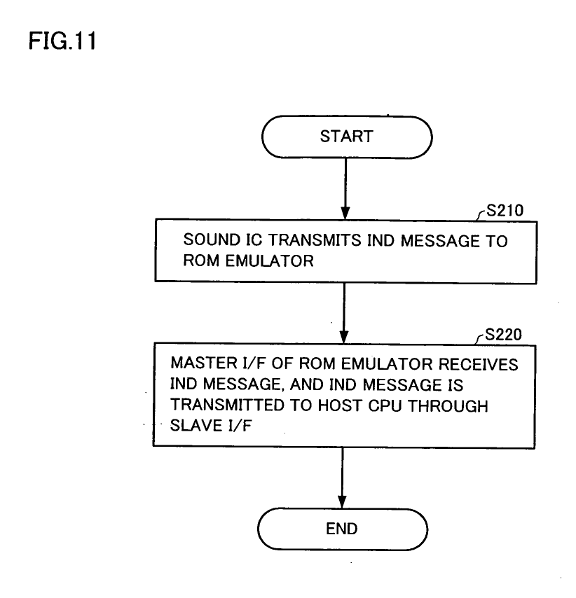

FIG. 11 shows a message flow (IND message) from the sound IC to the host CPU.

The sound IC transmits an ED message to the ROM emulator (step S210).

The master I/F of the ROM emulator receives the IND message, and the IND message is transmitted to the host CPU through the slave I/F (step S210).

The invention is not limited to the above-described embodiments, and various modifications can be made within the scope of the invention.

Although only some embodiments of this invention have been described in detail above, those skilled in the art will readily appreciate that many modifications are possible in the embodiments without materially departing from the novel teachings and advantages of this invention. Accordingly, all such modifications are intended to be included within the scope of the invention.

What is claimed is:

1. An emulation system that emulates a sound integrated circuit (IC) having a built-in read-only memory (ROM) and reproducing sound data stored in the built-in ROM or received sound data, the emulation system comprising:
a sound data storage section storing sound data to be stored in the built-in ROM;
a command reception section receiving a command issued to the sound IC;
a command conversion section that performs a command conversion process that converts a built-in ROM data reproduction command instructing reproduction of the sound data stored in the built-in ROM into a data-attached reproduction command to which reproduction target sound data is attached when the command conversion section has received the built-in ROM data reproduction command, the data-attached reproduction command having a format interpretable by the sound IC that reproduces the attached reproduction target sound data; and
a converted command transmission section that transmits the data-attached reproduction command to the sound IC,
the command conversion section reading sound data from the sound data storage section based on the received built-in ROM data reproduction command, and generating the data-attached reproduction command to which the read sound data is attached.

2. The emulation system as defined in claim 1,
when the command conversion section has received a combined data reproduction command instructing combination of a plurality of pieces of sound data stored in the built-in ROM and reproduction of the combined data, the command conversion section reading a plurality of pieces of corresponding sound data from the sound data storage section, combining the sound data to generate combined sound data, and generating the data-attached reproduction command to which the generated combined sound data is attached.

3. The emulation system as defined in claim 1,
when the command conversion section has received a combined data reproduction command instructing insertion of a silent interval between a plurality of pieces of sound data stored in the built-in ROM, combination of the plurality of pieces of sound data, and reproduction of the combined data, the command conversion section reading a plurality of pieces of corresponding sound data from the sound data storage section, combining the read sound data and silent data corresponding to the silent interval to generate combined sound data, and generating the data-attached reproduction command to which the generated combined sound data is attached.

4. The emulation system as defined in claim 1,
when the command conversion section has received a combined data reproduction command instructing combination of a plurality of pieces of sound data stored in the built-in ROM and reproduction of the combined data, the command conversion section reading a plurality of pieces of corresponding sound data from the sound data storage section, and generating a plurality of the data-attached reproduction commands to each of which a piece of the read sound data is attached; and
the converted command transmission section transmitting the plurality of generated data-attached reproduction commands to the sound IC.

5. The emulation system as defined in claim 1, comprising:
a protocol conversion device that functions as the command reception section and the converted command transmission section; and
a general-purpose computer that functions as the command conversion section,
wherein the protocol conversion device includes:
a first communication section that transmits and receives data to and from a host processor or the sound IC according to a first communication protocol;
a second communication section that transmits and receives data to and from the general-purpose computer according to a second communication protocol; and
a control section that transmits data received from the host processor or the sound IC to the general-purpose computer, and transmits data received from the general-purpose computer to the host processor or the sound IC; and
wherein the general-purpose computer performs the command conversion process based on a sound reproduction command received from the host processor through the protocol conversion device, and transmits the converted sound reproduction command to the sound IC through the protocol conversion device.

6. The emulation system as defined in claim 2, comprising:
a protocol conversion device that functions as the command reception section and the converted command transmission section; and
a general-purpose computer that functions as the command conversion section,
wherein the protocol conversion device includes:
a first communication section that transmits and receives data to and from a host processor or the sound IC according to a first communication protocol;
a second communication section that transmits and receives data to and from the general-purpose computer according to a second communication protocol; and
a control section that transmits data received from the host processor or the sound IC to the general-purpose computer, and transmits data received from the general-purpose computer to the host processor or the sound IC; and
wherein the general-purpose computer performs the command conversion process based on a sound reproduction command received from the host processor through the protocol conversion device, and transmits the converted sound reproduction command to the sound IC through the protocol conversion device.

7. The emulation system as defined in claim 3, comprising:
a protocol conversion device that functions as the command reception section and the converted command transmission section; and
a general-purpose computer that functions as the command conversion section,
wherein the protocol conversion device includes:
a first communication section that transmits and receives data to and from a host processor or the sound IC according to a first communication protocol;
a second communication section that transmits and receives data to and from the general-purpose computer according to a second communication protocol; and
a control section that transmits data received from the host processor or the sound IC to the general-purpose computer, and transmits data received from the general-purpose computer to the host processor or the sound IC; and
wherein the general-purpose computer performs the command conversion process based on a sound reproduction command received from the host processor through the protocol conversion device, and transmits the converted sound reproduction command to the sound IC through the protocol conversion device.

8. The emulation system as defined in claim 4, comprising:
a protocol conversion device that functions as the command reception section and the converted command transmission section; and
a general-purpose computer that functions as the command conversion section,
wherein the protocol conversion device includes:
a first communication section that transmits and receives data to and from a host processor or the sound IC according to a first communication protocol;
a second communication section that transmits and receives data to and from the general-purpose computer according to a second communication protocol; and
a control section that transmits data received from the host processor or the sound IC to the general-purpose computer, and transmits data received from the general-purpose computer to the host processor or the sound IC; and
wherein the general-purpose computer performs the command conversion process based on a sound reproduction command received from the host processor through the protocol conversion device, and transmits the converted sound reproduction command to the sound IC through the protocol conversion device.

9. The emulation system as defined in claim 5,
the control section of the protocol conversion device determining whether or not a command received from the host processor is the data-attached reproduction command, and transmitting the received command to the sound IC without performing a protocol conversion process and the command conversion process when the received command has been determined to be the data-attached reproduction command.

10. An emulation system comprising a host processor, a sound integrated circuit (IC) that reproduces sound data stored in a built-in read-only memory (ROM) or received sound data based on a command received from the host processor, and an emulator that emulates the sound IC,
wherein the sound IC includes:
the built-in ROM storing sound data;
a sound reproduction section that converts reproduction target sound data into an outputtable format and reproduces the converted sound data; and
a command processing section that transfers the reproduction target sound data to a sound output section based on a command received from the host processor;
wherein, when the command processing section has received a data-attached reproduction command, the command processing section transfers attached sound data to the sound reproduction section;
wherein, when the command processing section has received a built-in ROM data reproduction command, the command processing section reads the reproduction target sound data from the built-in ROM, and transfers the read reproduction target sound data to the sound reproduction section;
wherein the emulator includes:
a sound data storage section storing sound data to be stored in the built-in ROM;
a command reception section receiving a command issued to the sound IC;
a command conversion section that performs a command conversion process that converts the built-in ROM data reproduction command instructing reproduction of the sound data stored in the built-in ROM into the data-attached reproduction command to which the reproduction target sound data is attached when the command conversion section has received the built-in ROM data reproduction command, the data-attached reproduction command having a format interpretable by the sound IC that reproduces the attached reproduction target sound data; and
a converted command transmission section that transmits the data-attached reproduction command to the sound IC,
the command conversion section reading sound data from the sound data storage section based on the received built-in ROM data reproduction command, and generating the data-attached reproduction command to which the read sound data is attached.

11. An emulation method for emulating a sound integrated circuit (IC) having a built-in read-only memory (ROM) and reproducing sound data stored in the built-in ROM or received sound data, the emulation method comprising:
a storing step of storing sound data in a sound data storage section, the sound data being to be stored in the built-in ROM;
a receiving step of receiving a command issued to the sound IC;
a command conversion step of performing a command conversion process that converts a built-in ROM data reproduction command instructing reproduction of the sound data stored in the built-in ROM into a data-attached reproduction command to which reproduction target sound data is attached when the built-in ROM data reproduction command has been received, the data-attached reproduction command having a format interpretable by the sound IC that reproduces the attached reproduction target sound data; and
a converted command transmitting step of transmitting the data-attached reproduction command to the sound IC,
wherein, in the step of performing the command conversion process, sound data is read from the sound data storage section based on the received built-in ROM data reproduction command, and the data-attached reproduction command to which the read sound data is attached is generated.

12. The emulation method as defined in claim 11,
wherein, in the command conversion step, when a combined data reproduction command instructing combination of a plurality of pieces of sound data stored in the built-in ROM and reproduction of the combined data is received, a plurality of pieces of corresponding sound data are read from the sound data storage section, the pieces of the read sound data are combined to generate combined sound data, and the data-attached reproduction command to which the generated combined sound data is attached is generated.

13. The emulation method as defined in claim 11,
wherein, in the command conversion step, when a combined data reproduction command instructing insertion of a silent interval between a plurality of pieces of sound data stored in the built-in ROM, combination of the plurality of pieces of sound data, and reproduction of the combined data is received, a plurality of pieces of corresponding sound data are read from the sound data storage section, the pieces of the read sound data and silent data corresponding to the silent interval are combined to generate combined sound data, and the data-attached reproduction command to which the generated combined sound data is attached is generated.

14. The emulation method as defined in claim 11,
wherein, in the command conversion step, when a combined data reproduction command instructing combination of a plurality of pieces of sound data stored in the built-in ROM and reproduction of the combined data is received, a plurality of pieces of corresponding sound data are read from the sound data storage section, and a plurality of the data-attached reproduction commands to each of which a piece of the read sound data is attached are generated; and
wherein, in the converted command transmission step, the generated data-attached reproduction commands are transmitted to the sound IC.
